(19) United States
(12) Patent Application Publication
(10) Pub. No.: US 2015/0378591 A1
(43) Pub. Date: Dec. 31, 2015

(54) METHOD OF PROVIDING CONTENT AND ELECTRONIC DEVICE ADAPTED THERETO

(71) Applicant: Samsung Electronics Co., Ltd., Suwon-si (KR)

(72) Inventors: Changmo YANG, Anyang-si (KR); Bonghak CHOI, Goyang-si (KR); Zion KWON, Seoul (KR); Hyewon KIM, Seoul (KR); Ho KIM, Seoul (KR); Jungeui SEO, Anyang-si (KR); Hayoung JEON, Seoul (KR); Jinkyo CHUNG, Seoul (KR); Joonhyuk CHOI, Seoul (KR)

(21) Appl. No.: 14/747,512

(22) Filed: Jun. 23, 2015

(30) Foreign Application Priority Data
Jun. 27, 2014 (KR) 10-2014-0079409

(51) Int. Cl. G06F 3/0488; G06T 11/60; G06F 3/01; G06F 17/30; G06F 3/0484

(52) U.S. Cl. CPC G06F 3/04883; G06F 17/30023; G06F 3/04842; G06F 3/017; G06T 11/60

(57) ABSTRACT

A method of providing content in an electronic device and an apparatus for supporting the method are provided. The electronic device includes a communication unit configured to communicate with external devices, a display configured to display at least one content item, and a controller configured to detect a gathering gesture, gather content items stored in the electronic device and content items from the external devices in response to the gathering gesture, determine an order of displaying content items based on attributes of the gathered content items, and arrange and display the gathered content items according to the determined display order.

### CROSS-REFERENCE TO RELATED APPLICATION(S)

This application claims the benefit under 35 U.S.C. §119(a) of a Korean patent application filed on Jun. 27, 2014 in the Korean Intellectual Property Office and assigned Serial No. 10-2014-0079409, the entire disclosure of which is hereby incorporated by reference.

### TECHNICAL FIELD

The present disclosure relates to a method of providing content in an electronic device and an apparatus for supporting the method.

### BACKGROUND

Users are able to access and use various types of multimedia content with a single electronic device. Services for multimedia content, such as broadcasts, web content, user generated content, etc., have been diversified. However, while users are provided with improved services, users have difficulty searching for and finding content that they want.

The above information is presented as background information only to assist with an understanding of the present disclosure. No determination has been made, and no assertion is made, as to whether any of the above might be applicable as prior art with regard to the present disclosure.

### SUMMARY

When users seek for content items that they want using an electronic device, they must perform a number of operations which inconveniences them. For example, when a user seeks a content item related to a specific category, he/she must perform processes for accessing a search server, inputting a keyword, and reviewing the searched result for the content item, etc., a number of times.

Aspects of the present disclosure are to address at least the above-mentioned problems and/or disadvantages and to provide at least the advantages described below. Accordingly, an aspect of the present disclosure is to provide a method that easily and intuitively gathers corresponding content items from an electronic device and external devices, and automatically arranges and provides the gathered content items.

Another aspect of the present disclosure is to provide a method that gathers corresponding content items from the inside of an electronic device, obtains and gathers content items from external devices, such as a server and peripheral devices, and provides the content items without receiving a specific keyword such as text, etc.

In accordance with an aspect of the present disclosure, a method of providing content in an electronic device is provided. The method includes detecting a gathering gesture, gathering content items stored in the electronic device and content items from external devices in response to the gathering gesture, determining an order of displaying content items based on attributes of the gathered content items, and arranging and displaying the gathered content items according to the determined display order.

In accordance with another aspect of the present disclosure, an electronic device is provided. The electronic device includes a communication unit configured to communicate with external devices, a display configured to display at least one content item, and a controller configured to detect a gathering gesture, gather content items stored in the electronic device and content items from the external devices in response to the gathering gesture, determine an order of displaying content items based on attributes of the gathered content items, and arrange and display the gathered content items according to the determined display order.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a schematic block diagram of an electronic device according to various embodiments of the present disclosure;

FIGS. 2 and 3 illustrate diagrams that describe a process of providing content in an electronic device according to various embodiments of the present disclosure;

FIG. 4 is a flowchart that describes a method of providing content in an electronic device according to an embodiment of the present disclosure;

FIG. 5 is a flowchart that describes a method of providing content in an electronic device according to an embodiment of the present disclosure;

FIG. 6 is a flowchart that describes a method of providing content in an electronic device according to an embodiment of the present disclosure;

FIG. 7 illustrates screens that describe a method of providing content in an electronic device according to various embodiments of the present disclosure;

FIGS. 8A, 8B, 9, 10, 11A, 11B, and 12 illustrate gate screens on which gathered content items are managed according to various embodiments of the present disclosure;

FIG. 13 is a flowchart that describes a method of sharing content of an electronic device according to various embodiments of the present disclosure; and

FIGS. 14A, 14B, 15, 16, 17, and 18 illustrate wall page screens on which gathered content items are managed according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms or words described in the description and the claims should not be limited by a general or lexical meaning, instead should be analyzed as having a meaning and a concept through which the inventor defines and describes the present disclosure to the best of his/her ability, to comply with the idea of the present disclosure. Therefore, one skilled in the art will understand that the embodiments disclosed in the description and configurations illustrated in the drawings are only preferred embodiments of the present disclosure, instead there may be various modifications, alterations, and equivalents thereof to replace the embodiments at the time of filing this application.

In the various embodiments of the present disclosure, the electronic device may refer to a device that can connect to a network in wired/wireless mode and install and uninstall applications, for example, a smartphone, a tablet personal computer (PC), etc. The network may include the Internet and a mobile communication network.

The term ‘gathered content’ refers to content gathered from the inside of the electronic device or from an external device. The gathered content may include original data of content, summary information about content, e.g., thumbnail objects, address data of original data files, etc. For example, gathered content may include content created, based on a photograph, video, memo or note, navigation path, schedule, contact, call history or message history, web search information, application information, website information, document information, e-mail information, etc.

The term a ‘gathered content database’ (DB) may refer to a storage space for storing information related to gathered content. Gathered content may be stored and managed with an original file of content, a thumbnail or directory address, etc. The term a ‘gathering operating program’ may configure a content providing screen, based on gathered content, and may edit and manage the gathered content.

The term a ‘gate page screen’ refers to a screen on which gathered content items are called, arranged and displayed in order of display. A ‘wall page screen’ is a screen on which content items displayed on the gate page screen are edited and the edited, gathered content items are displayed.

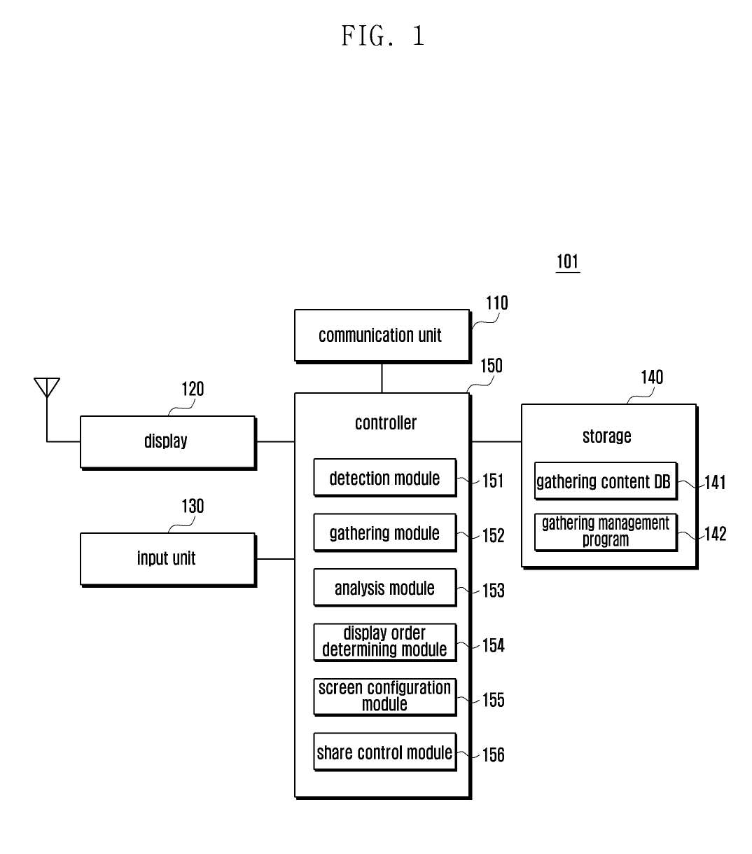

FIG. 1 illustrates a schematic block diagram of an electronic device according to various embodiments of the present disclosure.

Referring to FIG. 1, the electronic device 101 may include a communication unit 110, a display 120, an input unit 130, a storage 140, and a controller 150.

The communication unit 110 may make a video/voice call or perform data communication with an external device (e.g., other electronic device, a server, etc.) through a network in wired/wireless communication, under the control of the controller 150. Wireless communication may include at least one of Wi-Fi, Bluetooth (BT), Near Field Communication (NFC), Global Positioning System (GPS) or cellular communication (e.g., Long Term Evolution (LTE), LTE-Advanced (LTE-A), Code Division Multiple Access (CDMA), Wideband CDMA (WCDMA), Universal Mobile Telecommunications System (UMTS), Wireless Broadband (Wi-Bro), Global System for Mobile communications (GSM), etc.). Wired communication may include at least one of universal serial bus (USB), high definition multimedia interface (HDMI), recommended standard 232 (RS-232), plain old telephone service (POTS), etc.

The communication unit 110 may communicate with an external device authorized for communication connection with the electronic device 101 and may transmit and receive data related to gathered content to and from the external device.

The display 120 may display videos or data for the user. The display 120 may include a display panel. The display panel may be implemented with, for example, a Liquid Crystal Display (LCD), Active-Matrix Organic Light Emitting Diodes (AM-OLEDs), or the like. The display 120 may further include a display controller for controlling the display panel. The display panel may be implemented in a flexible, transparent, or wearable form. The display 120 may be combined with a touch panel to form a single module (e.g., a type of touch screen).

The display 120 may provide screens for providing various types of content as the content gathering function is executed.

The input unit 130 may create signals related to a user's settings and signals for controlling the operations of the electronic device (e.g., input signals required for operating the content gathering function) and may transfer them to the controller 150.

The input unit 130 may include a touch panel, a pen sensor, and keys. The touch panel may detect a user's touched input in at least one of for example, capacitive sensing mode, pressure sensing mode, infrared sensing mode, and ultrasonic sensing mode. The touch panel may further include a touch panel controller (not shown). When the touch panel is implanted to operate in capacitive sensing mode, it may sense direct touch and proximity of an object. The pen sensor may be implemented with an additional recognition sheet which works in the same way as receiving a user's touch input. Keys may be, for example, mechanical keys, touch keys, or the like.

The storage 140 may store data or instructions transmitted from the controller 150 or other components (e.g., display 120, input unit 130, communication unit 110, etc.) or data or instructions created by other components. For example, the storage 140 may store an operating system (OS) for booting the electronic device 101 and for controlling the components described above, at least one application, messages transmitted to/received from a network, data as applications are running, etc.

The storage 140 may include programming modules, e.g., a kernel, middleware, application programming interface (API), application module, etc. Each of the programming modules may be software, firmware, hardware or a combination of at least two or more.

The storage 140 may include a gathering content DB 141 and a gathering management program 142. The gathering content DB 141 may store content gathered from the inside of the electronic device 101 or from external devices. The gathering content DB 141 may store original file of gathered content, summary information about content (e.g., a thumbnail, or a directory address). The gathering management program 142 may support configuration of screens based on gathered content, edit of gathered content (addition, deletion, change, etc.), storage and edit of a wall page screen, a sharing function, control of connection with an external device, file export, etc.

The controller 150 may receive instructions from, for example, other components (e.g., a communication unit 110, display 120, input unit 130, storage 140, etc.), decode the received instructions, and process operations or data according to the decoded instructions. For example, when the electronic device 101 is turned on, the controller 150 may control a booting process for the electronic device 101, and may run various applications stored in a program area to execute corresponding functions according to a user's settings. The controller 150 may include more than one application processor (AP) or more than one communication processor (CP).

The controller 150 may include a detection module 151, a gathering module 152, an analysis module 153, a display order determining module 154, a screen configuration module 155, and a share control module 156.

The detection module 151 may detect gathering gestures. A ‘gathering gesture’ may be a touch- or hovering-based grip gesture, a pinch-in gesture, etc., and may be altered in manufacturing or according a user's settings. The detection module 151 may detect gathering gestures in a state in which the electronic device 101 can receive a touch input, e.g., a state where a home screen or a screen running an application is displayed.

In an embodiment of the present disclosure, when the detection module 151 detects a gathering gesture, it may select target content for gathering content items. For example, the detection module 151 may select, as target content, at least one of an app in execution or content in execution, content displayed on a location at which a gathering gesture has been detected, and content that has been selected. A selection standard of target content may be altered according the configuration of a screen displayed on the display. Users may make an action for selecting target content (e.g., a touch input for selecting content, etc.).

The gathering module 152 may gather content from the inside of the electronic device or from external devices in response to a gathering gesture. The content that has been gathered is hereafter called ‘gathered content.’

In an embodiment of the present disclosure, the gathering module 152 may gather content items that have been set as gathered content.

In an embodiment of the present disclosure, when the gathering module 152 gathers content from external devices, it may obtain content items from a storage space that has been set to share with external devices (e.g., a gathering DB, a sharing folder, etc.), in a form of summary information about content (e.g., a thumbnail, etc.).

In an embodiment of the present disclosure, when target content is selected, the gathering module 152 may extract an attribute of target content. The gathering module 152 may search in the electronic device for contents items with an attribute matching the extracted attribute of the target content. The gathering module 152 may gather searched content items. The attribute may include metadata about content and log information related to content. Metadata may be content name, time information, data format, location information, tag information, weather information, added information, etc. Log information may include history information about executions related to content in the electronic device, such as a connection log with external devices, an authorization log, a search log, etc.

In an embodiment of the present disclosure, the gathering module 152 may obtain content items that have been searched for on external devices based on attributes of target content. For example, after the gathering module 152 transmit attributes of target content to external devices and requests for searching for content items with attributes matching those of the target content from the external device, it may obtain summary information about the searched content items as gathered content items.

The analysis module 153 may compare the attributes of gathered content items with an attribute of target content, and may check the number of attributes matching the attribute of target content. The analysis module 153 may transmit the analysis result of the gathered content items to the display order determining module 154.

The display order determining module 154 may determine the order of displaying gathered content items based on the number of attributes matching the attribute of target content. For example, the display order determining module 154 may determine the display order of gathered content items to be arranged in order of the largest number of attributes matching those of the target content.

When there is no target content to match between attributes, the display order determining module 154 may determine the display order as the order of creation time of gathered content items (e.g., in order of most recently created). The display order determining module 154 may determine the display order in various ways according to information about the order setting or a user's settings.

The screen configuration module 155 may configure screens to provide gathered content obtained from the electronic device 101 (e.g., applications, memory, etc.) or from an external device. The gathered content providing screens may provide a gate page screen, on which gathered content items are called, arranged and displayed in order of display, and a wall page screen on which gathered content, edited on the gate page screen, is called and displayed. The screen configuration module 155 may be configured in such a way that the gathered content providing screen can be updated or altered according to a user's control input.

The share control module 156 may control connection with an external device. For example, in a state where an external device has been registered in the electronic device 101 or has been allowed for connection with the electronic device 101, when a gathering gesture is detected, the share control module 156 may control to communicate with the external device, based on the log information about the electronic device, without the user's authentication. When an event to request to share content is detected, the share control module 156 may communicate with an external device to perform transmission/reception of content, based on authentication information about the external device.

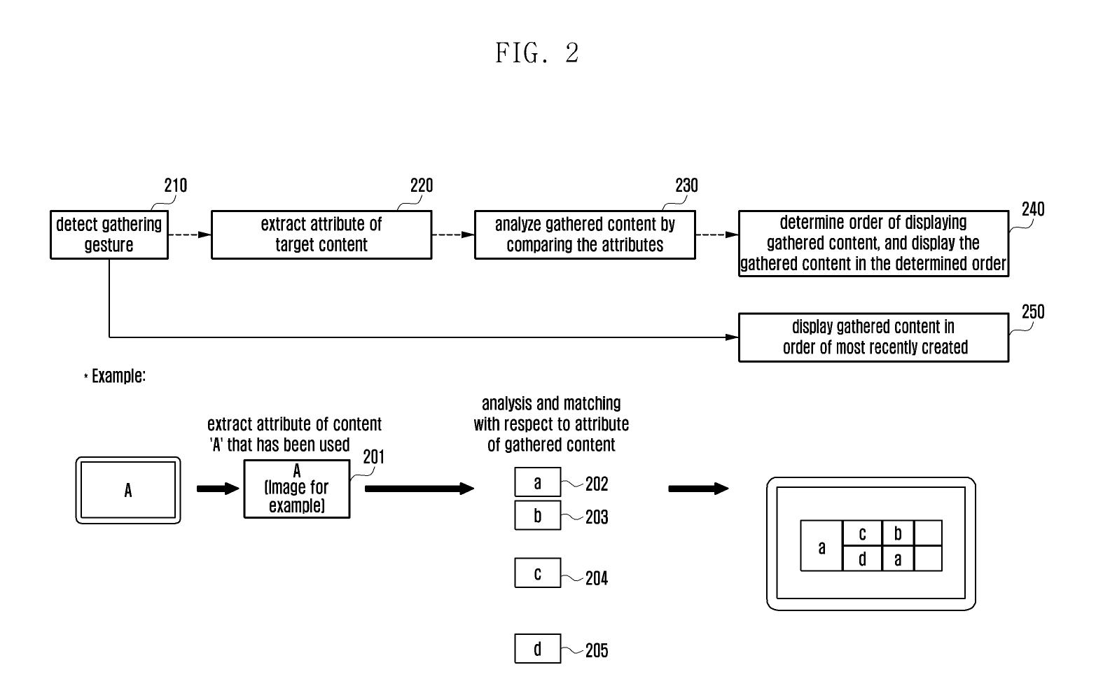

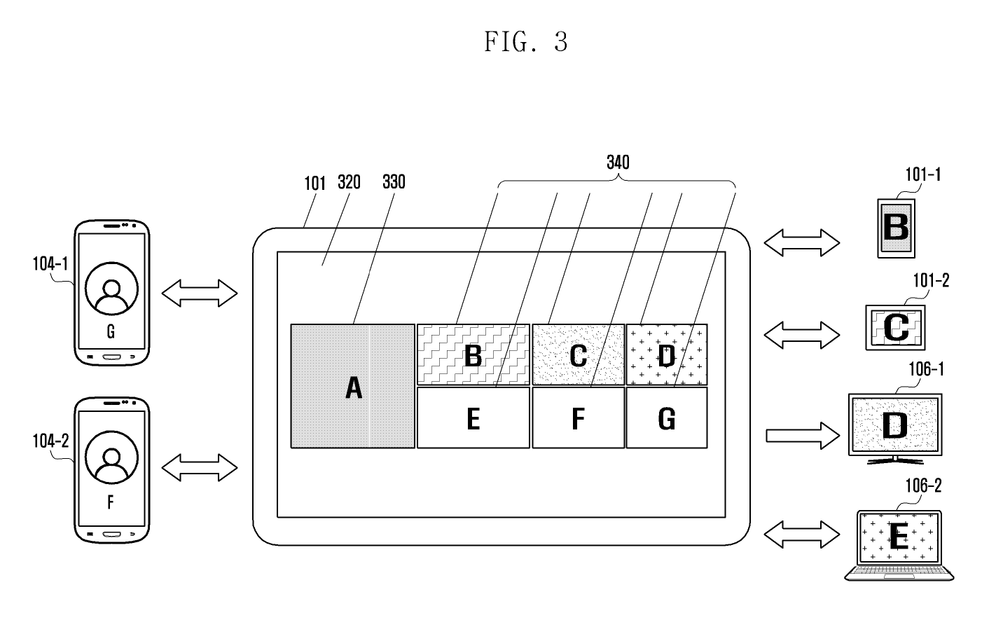

FIGS. 2 and 3 illustrate diagrams that describe a process of providing content in an electronic device according to various embodiments of the present disclosure.

Referring to FIG. 2, the electronic device (corresponding to the reference number 101 shown in FIG. 1) may be in a state where it can receive a touch input (e.g., a state where a home screen is displayed or an app execution screen is displayed). In order to gather corresponding content items, the user may make a gathering gesture on the touch screen.

The electronic device may detect a gathering gesture in process 210. The electronic device may extract an attribute of ‘A’ content 201 in process 220. The electronic device may select ‘A’ content 201 as target content and extract an attribute of the ‘A’ content 201. For example, when the ‘A’ content 201 is an image, the electronic device may extract attributes such as Image file Name <Travel>, Time & Date <2013/11/21>, Extension (File format) <JPG>, Location <Schilthorn, Switzerland>, Contacts <Jean pole>, Weather <Partly cloudy>, etc.

The electronic device may gather content stored in the inside of the electronic device or content obtained from external devices and analyze the gathered content by comparing the attributes in process 230. The electronic device may search the inside for content or request content from external devices, based on the attribute of ‘A’ content 201, and may obtain the searched content. For example, the electronic device may gather ‘a’ content 202, ‘b’ content 203, ‘c’ content 204, and ‘d’ content 205. The electronic device may compare the attributes of the gathered content items with that of the ‘A’ content 201 and check the number of matched attributes.

The electronic device may determine the order of displaying the gathered content items based on the number of matched attributes in process 240 and display the gathered content in the determined display order in process 250. For example, there may be one of the attributes of the ‘a’ content 202 which coincides with the attribute of the ‘A’ content, e.g., Time & Date <2013/11/21>. There may be three of the attributes of the ‘b’ content which coincide with the attributes of the ‘A’ content, e.g., Image file Name <Travel>, Time & Date <2013/11/21>, and Location <Schilthorn, Switzerland>. There may be five of the attributes of the ‘c’ content which coincide with the attributes of the ‘A’ content, e.g., Image file Name <Travel>, Time & Date <2013/11/21>, Extension (File format) <JPG>, Location <Schilthorn, Switzerland>, and Weather <Partly cloudy>. There may be two of the attributes of the ‘d’ content which coincide with the attributes of the ‘A’ content, e.g., Time & Date <2013/11/21> and Location <Schilthorn, Switzerland>. The electronic device may determine the order of displaying content items, based on the number of matched attributes, to be displayed starting from the largest number of matched attributes to the smallest: ‘c’ content 204, ‘b’ content 203, ‘d’ content 205 and ‘a’ content 202. The electronic device may provide gathered content items, in order of the largest number of attributes matching the attributes of the target content, on the screen.

When the electronic device detects a gathering gesture but may not select target content or when the gathered content items have the same number of matched attributes, the order of displaying gathered content items may be determined as the order of creating gathered content items. The electronic device may provide gathered content items in the determined display order on the screen.

Referring to FIG. 3, the electronic device 101 may display a content providing screen 320 configured with gathered content items 340.

When a gathering gesture is detected, the electronic device may gather content items in the internal storage. For example, the electronic device may gather content or sharing content, set to be gathered, from the internal storage (e.g., content stored in the gathering DB of the electronic device). As another example, when target content for a gathering process is selected, the electronic device may search for the stored content items, based on the attributes of the target content items, and may gather the searched content items. When the electronic device gathers the content items stored in the inside, it may gather the original content file.

The following table 1 describes types of gathered content items stored in the inside of the electronic device, but is not limited thereto.

TABLE 1

| Type | Content card | Application | Gathering |
|---|---|---|---|
| Media | Photograph | Gallery | |
| | Video | | |
| | S note | S Note | |
| Navigation | Path information | Google Map | |
| Schedule | Schedule on S planner | S Planner | |
| | Work to do on S planner | | |
| Contact | Contacts (Name/Phone | Contact | |
| | number/e-mail/etc.) | | |
| Log | Call/message log | phone/messaging/ | |
| | | chaton | |
| Web | (Internet search result) | Internet | |
| Search | photographs | | |
| | (Internet search result) | | |
| | Traffic information | | |
| | (Internet search result) | | |
| | Weather | | |
| | (Internet search result) | | |
| | News | | |
| | (Internet search result) | | |
| | Encyclopedia | | |
| Application | Application | — | |
| Web Site | Website | Internet | |
| Document | Office document | My files/ | |
| | (Presentation, Word, Sheet, | Download/ | |
| | Portable Document Format | Office app | |
| | (PDF)) | | |
| Scrap Book | Scraped content | Scrapbook | |
| Email | Email content (title/body/ | Email | |
| | attached file) | | |
| Sharing | (Music) music | Samsung | |
| App. | (Video) video | Hub | |
| | (Books) e-book | | |
| | (Games) games | | |
| | (Learning) courses | | |

In addition, when a gathering gesture is detected, the electronic device may perform a connection process to an external device and may gather content from the external device. The external device may be at least one of a user's personal devices 101-1 and 101-2, another electronic device 104-1 capable of performing short-range communication, other electronic device 104-2 which has been registered in the electronic device based on a contact or an account, and servers 106-1 and 106-2.

According to various embodiments of the present disclosure, for a device that has been authenticated for connection, the electronic device may gather content sharing with external devices (e.g., content stored in a gathering DB of the external device). In that case, the electronic device may receive not an original data file of content but the summary information about content (e.g., thumbnail information, source information about content) as gathered content. The electronic device may gather content items as content set information stored by respective content items or in the form of wall page.

The following Table 2 describes types of content items gathered from external devices, but is not limited thereto. The electronic device may receive not a real original data file of content items but the summary information about content items from external devices. When a transmission request for an original data file is made, the electronic device may receive a real data file from the external devices.

TABLE 2

| | | | Gathering | |
|---|---|---|---|---|
| | | | | External |
| | | | | device of |
| | | | A user's | another |
| | | | other | user's |
| Type | Content card | Application | device | account |
| Media | Photograph | Gallery | | |
| | Video | | | |
| | S note | S Note | | |
| Navigation | Path information | Google Map | | X |
| Schedule | Schedule on S planner | S Planner | | X |
| | Work to do on S | | | |
| | planner | | | |
| Contact | Contacts (Name/Phone | Contact | | X |
| | number/e-mail/etc.) | | | |
| Log | Call/message log | phone/ | | X |
| | | messaging/ | | |
| | | chaton | | |
| Web | (Internet search result) | Internet | X | X |
| Search | photographs | | | |
| | (Internet search result) | | | |
| | Traffic information | | | |
| | (Internet search result) | | | |
| | Weather | | | |
| | (Internet search result) | | | |
| | News | | | |
| | (Internet search result) | | | |
| | Encyclopedia | | | |
| Application | Application | — | X | X |
| Web Site | Website | Internet | X | X |
| Document | Office document | My | | |
| | (Presentation, | files/ | | |
| | Word, Sheet, | Download/ | | |
| | PDF) | Office | | |
| | | app | | |
| Scrap | Scraped content | Scrapbook | | |
| Book | | | | |
| Email | Email content | Email | | X |
| | (title/body/ | | | |
| | attached file) | | | |
| Sharing | (Music) music | Samsung | | X |
| App. | (Video) video | Hub | | X |
| | (Books) e-book | | | X |
| | (Games) games | | | X |
| | (Learning) courses | | | X |

In this process, when there is an external device capable of performing short-range communication, the electronic device may request to connect to the external device and may perform an approving process with respect to the request for connection with the external device, before a gathering process. For an external device that has been authenticated for connection, the electronic device may access a storage storing content set to share, without an additional approval procedure that need to be performed each time that content of the external device is gathered, and may gather content. When the electronic device is connected to an external device with short-range communication, if the electronic device is out of the range for the short-range communication network, it may be automatically disconnected with the external device. When the electronic device approaches within the range for the short-range communication network, it may be automatically re-connected to the external device. According to various embodiments of the present disclosure, the electronic device may control connection with an external device according to the menu settings.

The electronic device may control a screen by arranging gathered content items in order of highest relevance to content in use. For example, the electronic device may extract attributes of ‘A’ content 330, compare the attributes of ‘A’ content 330 with attributes of gathered content items 340, and display the gathered content items 340 in order of the largest number of matched attributes. For example, the gathered content items may have the number of attached attributes in order of B-E-C-F-D-G.

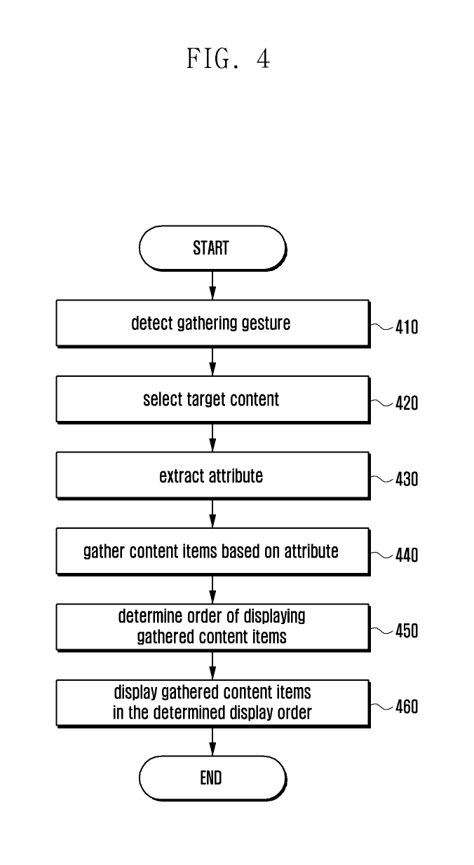

FIG. 4 is a flowchart that describes a method of providing content in an electronic device according to an embodiment of the present disclosure.

Referring to FIG. 4, the electronic device may detect a gathering gesture at operation 410. The electronic device may run in a state where it can receive a touch or hovering input. For example, the electronic device may detect a gathering gesture on a home screen or an application executing screen.

When detecting a gathering gesture, the electronic device may select target content based on information displayed on the screen at operation 420.

When selecting target content, the electronic device may extract attributes of the target content at operation 430. The electronic device may search the inside or an external device for content items related to the target content, based on the extracted attributes of the target content, and may gather the searched content items at operation 440.

For example, when target content is selected, the electronic device may extract attributes of the target content, set the extracted attributes as search keys, and search the stored content items for content items with the extracted attributes. The electronic device may store the searched content items as gathered content. In that case, the electronic device may store directory address data storing real original data corresponding to the searched content items in the gathering DB. The electronic device may obtain content items that an external device was searched for, based on attributes of target content.

As another example, when the electronic device has not stored attributes of target content (e.g., when photographs transmitted from a web server are selected as target content), it may request attributes of target content from external devices. When the electronic device obtains attributes of target content from the external devices, it may search the inside based on the obtained attributes of target content for content items and gather the searched content items.

The electronic device may compare attributes of gathered content items with those of target content, check the number of attributes of gathered content items matching the attributes of target content, and determine the order of displaying gathered content items based on the number of matched attributes at operation 450.

The electronic device may display the gathered content items in the display order of target content on the display at operation 460.

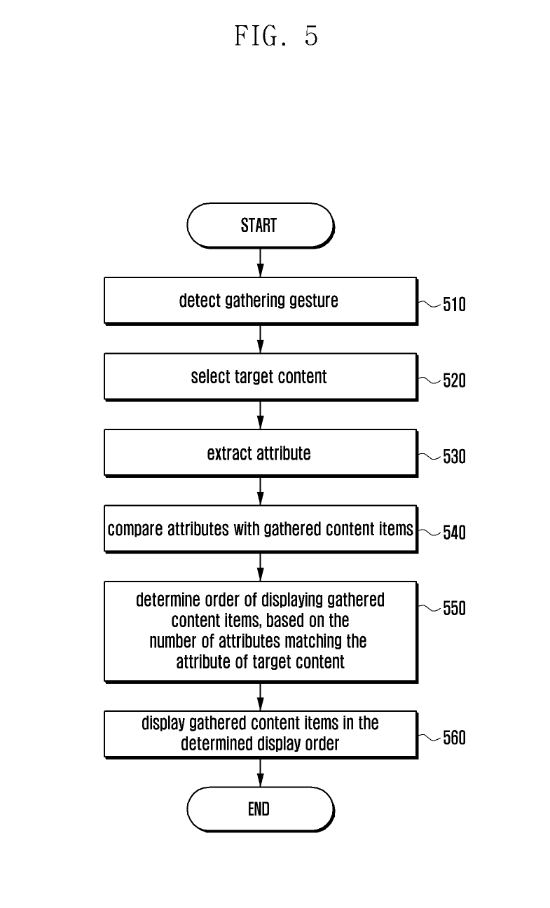

FIG. 5 is a flowchart that describes a method of providing content in an electronic device according to an embodiment of the present disclosure.

Referring to FIG. 5, the electronic device may detect a gathering gesture a state where it can receive a touch input at operation 510. The electronic device may select target content based on the detected gathering gesture at operation 520.

The electronic device may extract attributes of the target content at operation 530. The electronic device may compare attributes of gathered content items with those of target content, and check the number of attributes of gathered content items matching the attributes of target content at operation 540.

For example, the electronic device may gather attributes of content items stored in a DB set to share with external devices, compare attributes of gathered content items with those of target content, and check the number of attributes of gathered content items matching the attributes of target content.

As another example, when the electronic device has registered a user's personal device, it may gather content items from the user's personal device registered, without requesting the approval procedure for gathering content items from the user's personal device. When a user's other account has already set sharing content items, the electronic device may obtain and gather content items from external devices, without requesting an approval procedure for gathering content items.

As another example, for external devices of other accounts, the electronic device may transmit a request for approving of a gathering process to the external devices of other accounts, each time that the electronic device gathers content items from the external devices, and may obtain and gather designated content items when approving of a user of other account.

The electronic device may determine the order of displaying gathered content items, based on the number of attributes matching attributes of target content at operation 550. The electronic device may display the gathered content items in the display order of target content on the display at operation 560.

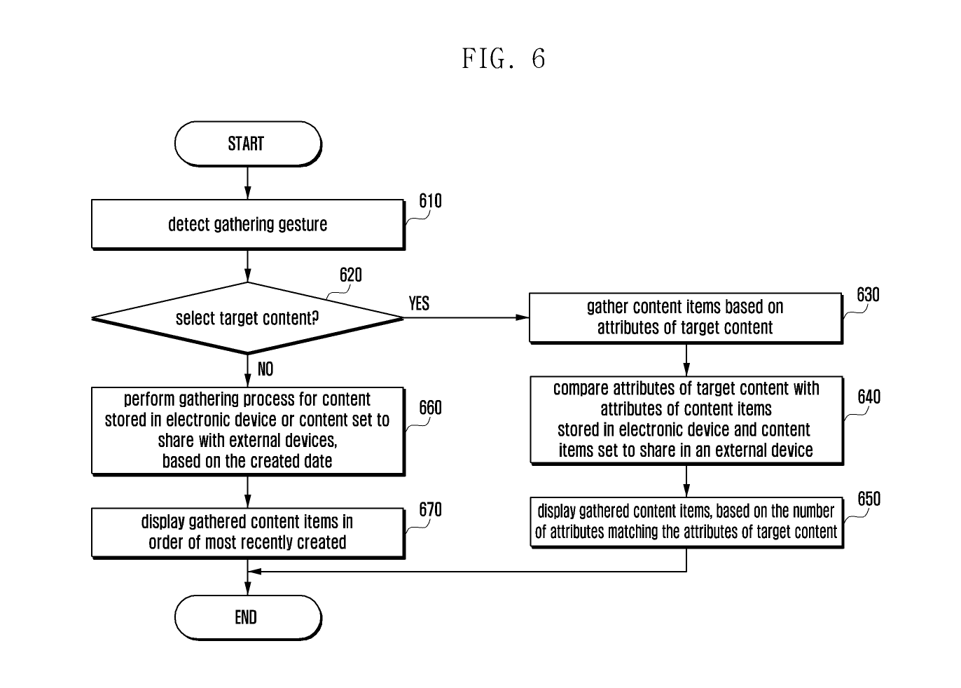

FIG. 6 is a flowchart that describes a method of providing content in an electronic device according to an embodiment of the present disclosure.

Referring to FIG. 6, the electronic device may detect a gathering gesture at operation 610. The electronic device may determine whether to select target content at operation 620. When target content has been selected in operation 620, it may gather content items based on attributes of the target content at operation 630. For example, the electronic device may search content items stored in the storage or content items set to share in external devices for content items with attributes identical to those of the target content, and may gather the content items.

The electronic device may compare attributes of target content with attributes of gathered content items and may determine the order of displaying gathered content items at operation 640.

The electronic device may display gathered content items, based on the number of attributes matching the attributes of target content at operation 650. For example, the electronic device may determine the display order of gathered content items based on the order of the largest number of matched attributes, and may display the gathered content items in the determined display order.

When target content has not been selected in operation 620, the electronic device may gather content items from the content items stored in the electronic device or content items set to share in external devices, based on the created date at operation 660.

The electronic device may display the gathered content items in order of most recently created at operation 670.

The electronic device may detect a user's various input actions in a state where gathered content items are displayed. The electronic device may display the gathered content items by updating or altering them according to a user's various input actions.

In the following description, although a method of controlling gathered content through a gathered content providing screen is described based on a screen interface, it should however be understood that the present disclosure is not limited to the embodiment.

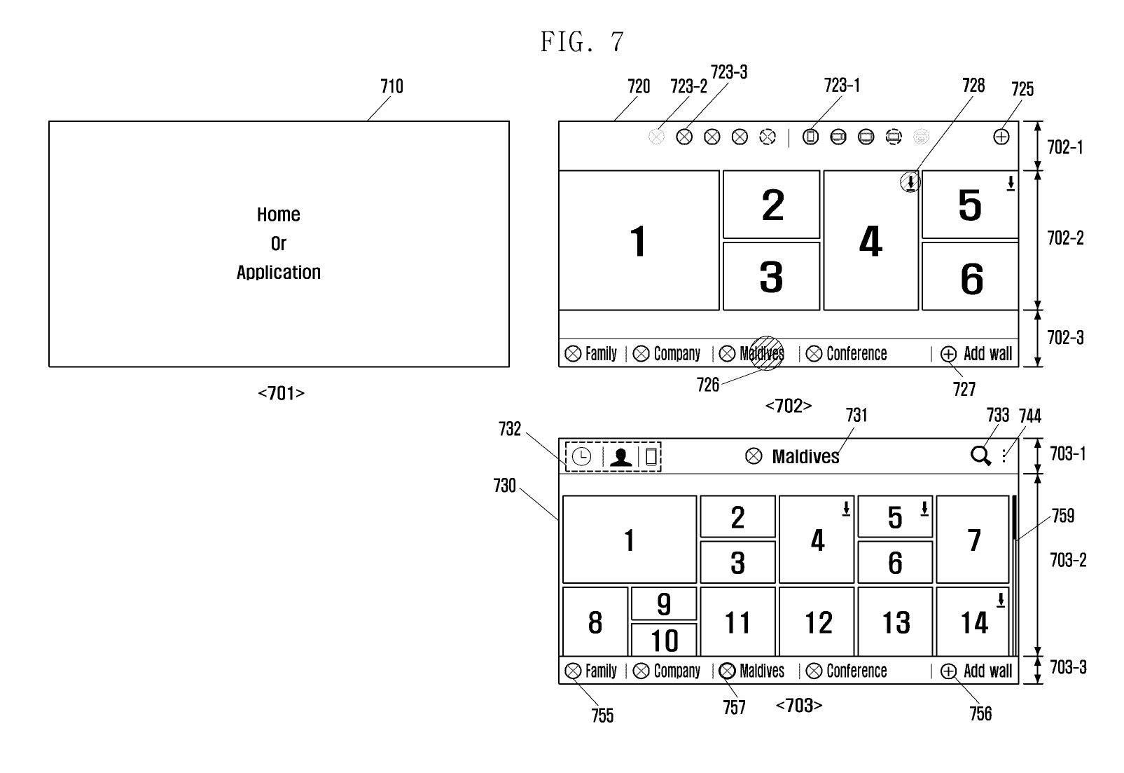

FIG. 7 illustrates screens that describe a method of providing content in an electronic device according to various embodiments of the present disclosure.

Referring to FIG. 7, the electronic device may display a home screen or an application execution screen 710 on the display as shown in diagram 701. The user may make a gathering gesture (e.g., a grip gesture, a pinch-in gesture, etc.) on the display on which a home screen or an application execution screen 710 is displayed.

The electronic device may detect a gathering gesture and call gathered content items in response to the detected gathering gesture. In that case, as shown in diagram 702 of FIG. 7, the electronic device may display a gate page screen 720 showing gathered content on the display. The electronic device may determine the order of displaying gathered content items according to the method described above referring to FIG. 6. For example, when the electronic device detects a gathering gesture on a home screen, it may display the gathered content items in order of most recently created. When the electronic device detects a gathering gesture on an application executing screen, it may display the gathered content items in order of the number of attributes matching the attributes of app content.

The gate page screen 720 may include a menu area 702-1 for managing gathered content, a content displaying area 702-2, and a wall page menu area 702-3. The menu area 702-1 may include an external device list and device adding menu 725. The external device list may include a group of external devices (e.g., 723-2 and 723-3) of other accounts and a group of user personal devices (e.g., 723-1). The external device list may include a connection device (e.g., 723-3) registered in the electronic device; a non-connection device (e.g., 723-2) registered in the electronic device; and device identification objects 723-1, 723-2, and 723-3, which are within a range of short-range communication network of the electronic device and corresponds to external devices. The electronic device may provide an image effect for a device identification object 723-3 corresponding to a connection device and an image effect for a device identification object 723-2 corresponding to the non-connection device, which differ from each other.

The device adding menu 725 is a menu item for adding external devices. When the electronic device detects a user's input (e.g., a tap) for selecting a device adding menu, it may display a setup screen for adding an external device on the display. The setup screen for adding external devices may be implanted with a pop-up window, but is not limited thereto.

The wall page menu area 702-3 may include wall page items 726 and a wall page adding menu 727. The wall page means information collecting results produced as content items are called and edited on the gate page screen. The electronic device may allocate a wall storage area corresponding to one wall page, store and manage gathered content items, by allocated wall storage areas. The wall page item 726 may include an icon for identifying a created wall page screen, or page name information.

The wall page adding menu 727 is a menu item for creating a wall page screen. When the electronic device detects a user's input (e.g., a tap) for selecting a wall page adding menu, it may display a setup screen for adding a wall page screen, as a pop-up window, on the display.

The content displaying area 702-2 means an area on which content items stored in the electronic device or content items gathered from external devices are called and displayed. The electronic device may automatically arrange content items in order of displaying gathered content items. For example, as shown in diagram 702, the electronic device may configure a screen, arranging gathered content items, in order of content 1, content 2, content 3, content 4, content 5 and content 6. The arrangement of content items may be determined based on screen configuration templates, but is not limited thereto.

For example, content 1 may be target content. As shown in diagram 702, the electronic device may arrange content 2 to content 6 in order of highest relevance to target content (e.g., in order of the largest number of attributes matching the attributes of content 1). In addition, when target content has not been selected, the electronic device may arrange content 1 to content 6 in order or most recently created.

The electronic device may display gathered content items by separating content based on real original data from content based on summary information. For example, content 4 and content 5 may be content gathered by obtaining only summary information (e.g., thumbnail information) from external devices. When gathered content items are called in a thumbnail form, the electronic device may provide a download button 728 for downloading the original data files.

When the electronic device detects a user's input applied to the download button 728, it may connect to the external device that has provided content items in a thumbnail form and may download the original data files of the content items. When the electronic device has downloaded an original data file, it may update the gathered content in a thumbnail form with the downloaded original data file.

Meanwhile, as shown in diagram 702, the electronic device may receive a user's input a in a state where it displays a gate page screen 720 to return to a home screen or application execution screen 710. For example, users may make a pinch-out gesture or press a back or home button on the gate page screen. In that case, the electronic device may return the gate page screen to a home screen or application execution screen 710 as shown in diagram 701.

As shown in diagram 702, users may make a user's input (e.g., a tap) for selecting a wall page item 726 on the gate page screen 720. The electronic device may call and display a wall page screen 730 on the display in response to the user's input for selecting the wall page item 726 as shown in diagram 703.

The wall page screen 730 may include a wall title area 703-1, a wall content display area 703-2 and a wall page menu area 703-3. The wall title area 703-1 may display a title item of a wall page 731 and wall page managing menus. The wall page managing menu may include a menu 733 for searching wall pages for content, an edit menu 744, and a menu 732 (e.g., time series item, content provider item, personal device items, etc.) for sorting content items in a wall. According to various embodiments of the present disclosure, the electronic device may also display information about the number of external devices sharing a corresponding wall page screen (not shown) on the title item.

Since the wall page menu area 703-3 is the same as the wall page menu area shown in diagram 702, its detailed explanation is hereafter omitted. The electronic device may display a wall page item 757 on the display, differing from another wall page item 755, in at least one of effect, color, and form. The wall page menu area 703-3 may also include a wall page adding menu 756.

The wall content display area 703-2 may be an area on which content items stored in a storage area allocated to a wall page are called and displayed. The wall content display area 703-2 may call and arrange content items in order of content 1 to content 14. Since the display function of wall content is the same as the content display function of the gate page screen, its detailed explanation is omitted.

While the wall content display area 703-2 of the gate page screen 730 arranges content items in columns, the content display area 702-2 of the wall page screen 720 may arrange content items in rows.

The wall content display area 703-2 may provide a scroll search bar 759 for searching for content items arranged in column. The electronic device may control the scroll search bar 759 in such a way that the bar 759 is displayed when a wall page screen is called for the first time and then disappears after a period of time has elapsed. When the electronic device detects a touch input moving up or down on the wall page screen, it may re-display the scroll search bar 759.

The electronic device may display, on the screen, information about an external device which has provided gathered content to a wall page screen and/or the most recent update of gathered content on a wall page screen. For example, when information about external devices of accounts, Tom, Kelly, and Amy is displayed on a wall page screen ‘Maldives’ on the screen of the electronic device, the user may recognize that content items are gathered from the external devices of accounts, Tom, Kelly, and Amy through the wall page screen ‘Maldives.’

In the following description, a method of managing gathered content through a gate page screen and a wall page screen is explained based on various screens.

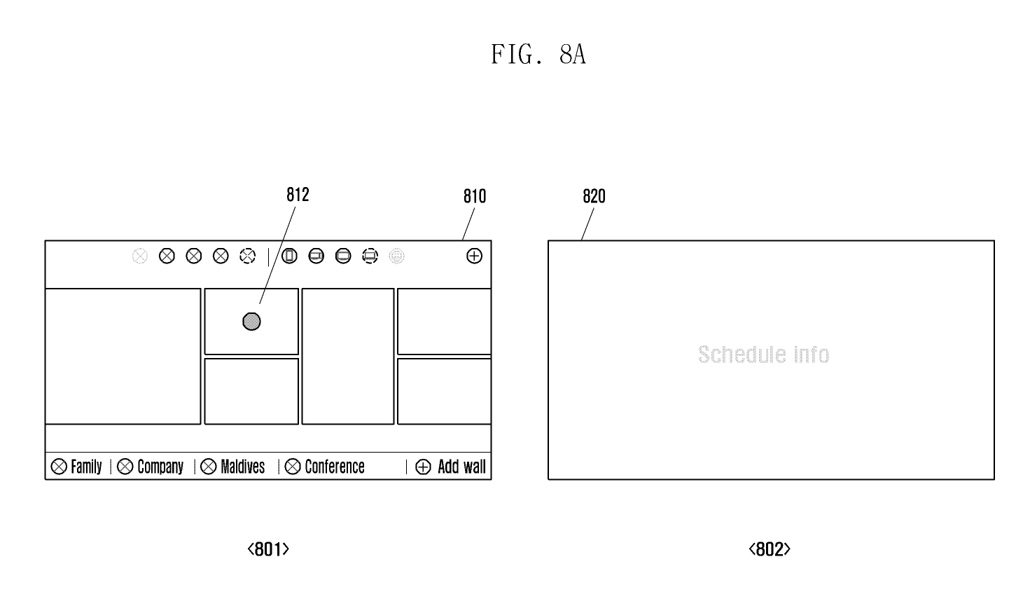

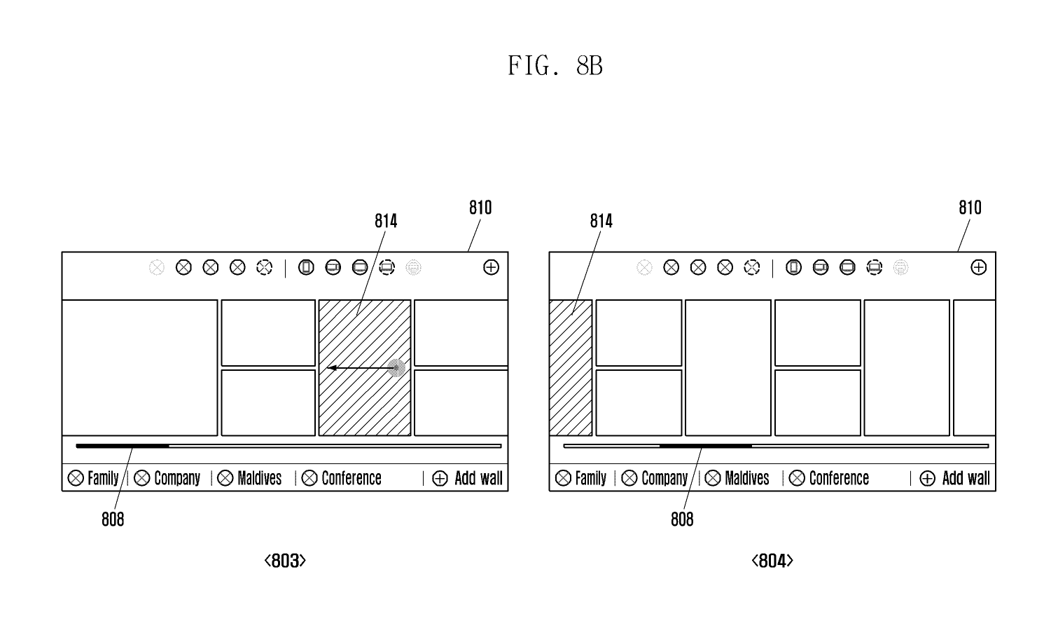

FIGS. 8A, 8B, 9, 10, 11A, 11B, and 12 illustrate gate screens on which gathered content items are managed according to various embodiments of the present disclosure.

Referring to FIGS. 8A and 8B, the electronic device may provide a function for managing and editing gathered content items on the gate page screen 810. The user may make various actions for user's control inputs to manage and edit gathered content on the gate page screen 810.

As shown in diagram 801 of FIG. 8A, the user may make a touch input (e.g., a tap) for selecting one of the gathered content items displayed on the gate page screen 810. The electronic device may detect a user's touch input and select gathered content 812 displayed at the location where the touch input is detected. As shown in diagram 802, the electronic device may display a detail display screen 820 for displaying details about the selected content item on the display.

When content selected to display details is called in thumbnail form, the electronic device may communicate with an external device that has provided the selected content and may notify the user to check whether to download the original data file. After downloading the original data file of the content called in a thumbnail form, the electronic device may display the detail display screen 820 on the display as shown in diagram 802.

In a state where a detail display screen 820 is displayed, when the electronic device detects a user's input for returning to the gate page screen 810 (e.g., when the back button is pressed), it may return to the gate page screen 810.

As shown in diagram 803, the user may perform a user's input (e.g., a flick or a scroll moving both sides, etc.) for searching for gathered content in a state where the gate page screen 810 is displayed. As shown in diagram 804, in response to the user's input for search for gathered content, the electronic device may search for gathered content items 814 arranged in the content display area in both sides. The electronic device may display a search bar 808 on the content display area so that the user can recognize the search location. The electronic device may arrange a plurality of content items, in column, on the gate page screen 810. For example, the gathered content 814 shown in diagram 803 is arranged in the center of the gate page screen, while the gathered content 814 shown in diagram 804 is moved to the left of the gate page screen and arranged at the moved location.

According to various embodiments of the present disclosure, the electronic device may provide functions for correcting and editing information about a wall page title. For example, when the user selects (e.g., taps) information about a wall page title (731 of FIG. 7), the electronic device may provide a setup screen for correcting or editing a title image and title name. The setup screen may be provided in a pop-up window, but is not limited thereto.

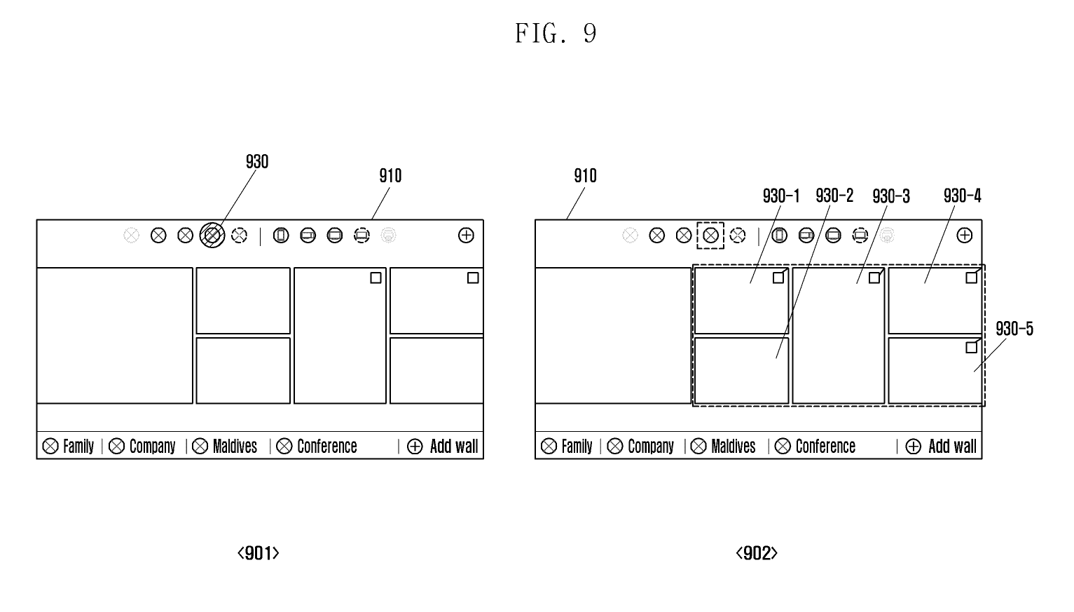

Referring to FIG. 9, the electronic device may provide a function for re-arranging gathered content based on external devices. As shown in diagram 901, the electronic device may display a gate page screen 910 that calls gathered content items obtained from external devices connected to the electronic device in order of display.

When the user needs to call gathered content items obtained from only a specific external device, he/she may perform a first touch input (e.g., a tap) for selecting an external device identification object 930. When the electronic device detects a touch input (e.g., a tap) for selecting an object 930 for identifying the external device, it may select gathered content items obtained from the selected external device in response to the detected input. As shown in diagram 902, the electronic device may display the selected gathered content items 930-1, 930-2, 930-3, 930-4 and 930-5 on the content display area.

According to various embodiments of the present disclosure, the user may perform a second touch input (e.g., a long press) for selecting an external device identification device (object). Although not shown, when the electronic device detects the second touch input, it may call a setup menu for removing the selected external device from the external device list. When the user approves of the removal request of the selected external device, the electronic device may remove the identification device of the selected external device from the external device list.

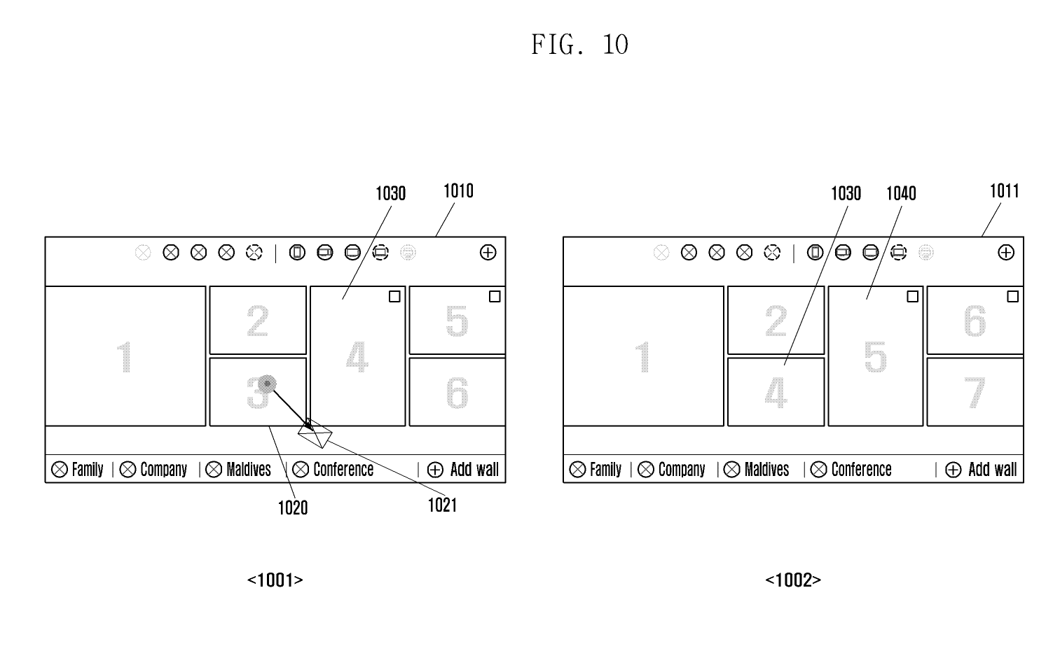

Referring to FIG. 10, the electronic device may provide a function for deleting gathered content through a gate page screen 1010. As shown in diagram 1001, the electronic device may display a gate page screen 1010 on the display.

When the user needs to remove specific content from the content display area, he/she may select the specific content and then perform a user's input for removing the selected, specific content. For example, the user's input for removing content from the gate page screen 1010 may be an input that selects one content item 1020 and drags it out of the content display area. In that case, when the user selects and drags specific content 1020, the electronic device may display a moved object 1021 corresponding to the selected content 1020. The moved object 1021 may be an object that is displayed to provide the user with the movement information about the corresponding content.

As shown in diagram 1002, when the selected content item 1020 is removed, the electronic device may automatically re-arrange and display gathered content items in the location from which the content item 1020 was removed in order of display. For example, when the user needs to remove content 1020, he/she may select the content 1020 and drag and drop it. The electronic device may display the moving object 1021 corresponding to the content 1020. When the moving object 1021 is moved out of the content display area, the electronic device may delete the content 1020 from the content display area. When the content 1020 is removed, the electronic device may display a page screen 1011 on which content items 1030, 1040, etc. are re-arranged in order of display.

According to various embodiments of the present disclosure, although not shown in the drawing, the user may select specific gathered content, perform a drag and drop gesture to move the selected content to a location where target content has been located. The electronic device may alter the moved gathered content to the target content and may call gate page screens, re-arranged in order of high relevance, based on the altered target content.

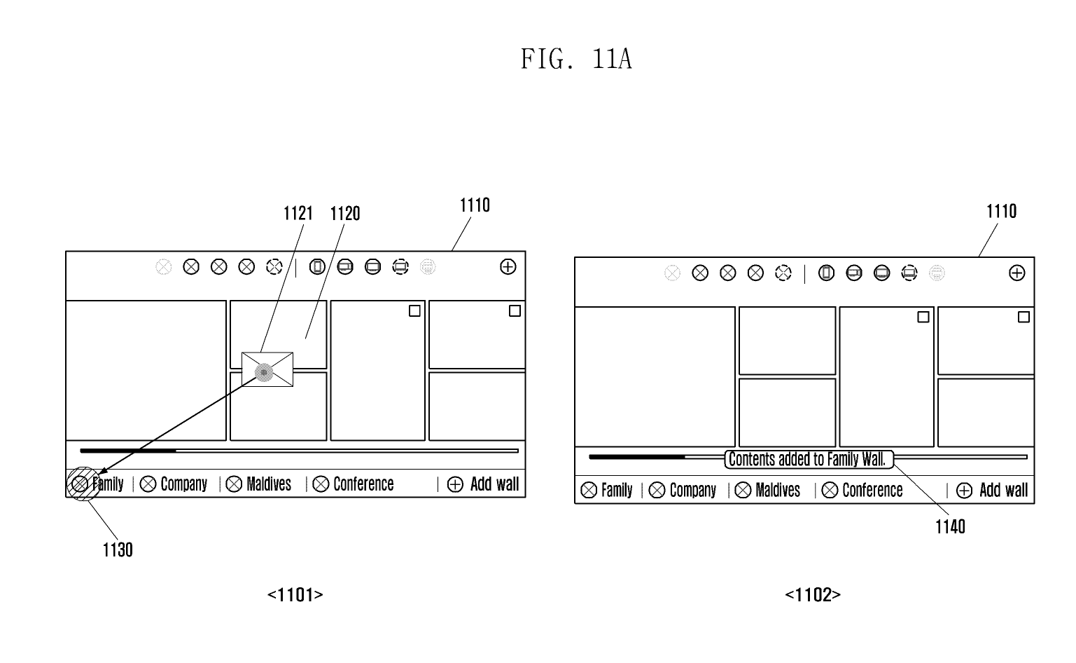

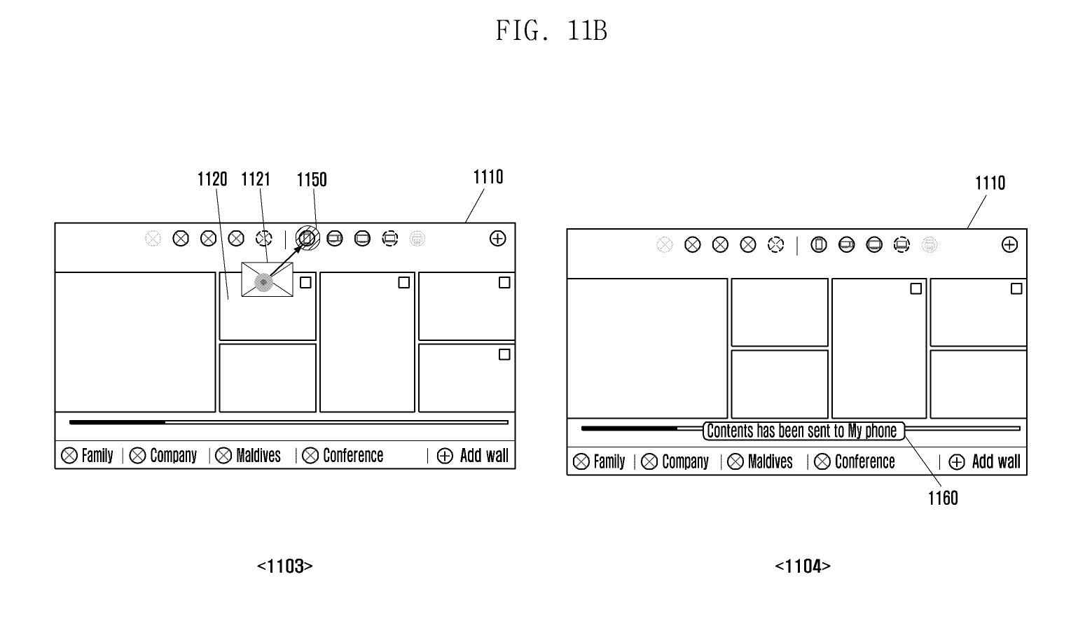

Referring to FIGS. 11A and 11B, in order to store and manage gathered content items as a wall page, the electronic device may support a function for editing content items on the gate page screen. As shown in diagram 1101, the electronic device may display a gate page screen 1110 calling at least one or more gathered content items.

When the user needs to store specific gathered content in a specific wall page, he/she may select the specific, gathered content and may make a drag and drop gesture to move it to the location of the wall page item 1130. When the user selects specific gathered content and drags it, the electronic device may display a moving object 1121 corresponding to the selected gathered content 1120.

When the moving object 1121 is moved to a location of the wall page item 1130, the electronic device may add the selected, gathered content 1120 to an allocation space in the selected wall page.

For example, the electronic device may allocate additional storage spaces according to wall pages. The electronic device may store the selected content in a storage space allocated for the selected wall page.

When the selected, gathered content 1120 has been moved to the selected wall page screen, the electronic device may display a notification 1140 on the screen, informing that the selected, gathered content 1120 has been added to the selected wall page screen, as shown in diagram 1102.

In addition, the electronic device may support a function for sharing gathered content with other external devices on the gate page screen. When the user needs to share specific, gathered content with external devices, he/she may select specific, gathered content and make a drag-and-drop gesture at a location of the external device identification item 1150 as shown in diagram 1103 of FIG. 11B. When the user selects specific, gathered content and drags it, the electronic device may display a moving object 1121 corresponding to the selected gathered content 1120.

When the moving object 1121 is moved to a location where the external device identification item 1150 is located, the electronic device may transmit the selected specific gathered content 1120 to the selected external device. When the selected specific gathered content 1120 has been transmitted to the selected external device, the electronic device may display a notification 1160 on the screen, informing that the selected specific gathered content 1120 has been transmitted to the selected external device, as shown in diagram 1104.

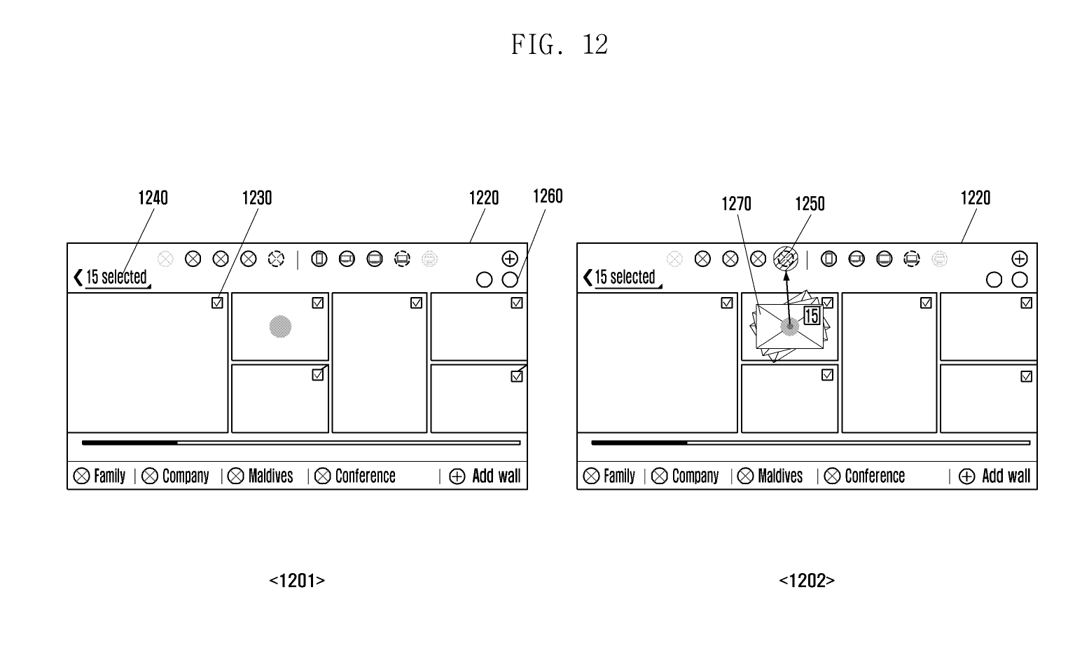

Referring to FIG. 12, the electronic device may support a function for selecting multiple gathered content items and a function for selecting and editing multiple gathered content items. The user may touch a gathered content item and perform a long press input thereto in a state where a gate page screen is displayed.

When the electronic device detects a long press input on the gate page screen, it may switch the screen to a screen 1220 for selecting multiple gathered content items as shown in diagram 1201. For example, the electronic device may provide respective checkboxes 1230 for selecting corresponding content items. The user may select a plurality of content items by clicking, or ticking, the checkboxes. When content items are selected, the electronic device may display the number of selected content items 1240 and menu items 1260 on the top of the screen. The menu items 1260 may provide functions for removing and sharing multiple gathered content items that have been selected.

In a state where multiple content items have been selected on the screen 1220 for selecting multiple gathered content items, when the user applies a long press input, the electronic device may display moving objects 1270 corresponding to the selected content items as shown in diagram 1202.

When the user moves the moving objects 1270 to a location where the external device identification item 1250 is located, the electronic device may transmit the selected, plurality of gathered content items to the selected external device corresponding to the external device identification item 1250. When the plurality of content items have been transmitted, the electronic device may display a notification on the screen, informing that the transmission has been completed.

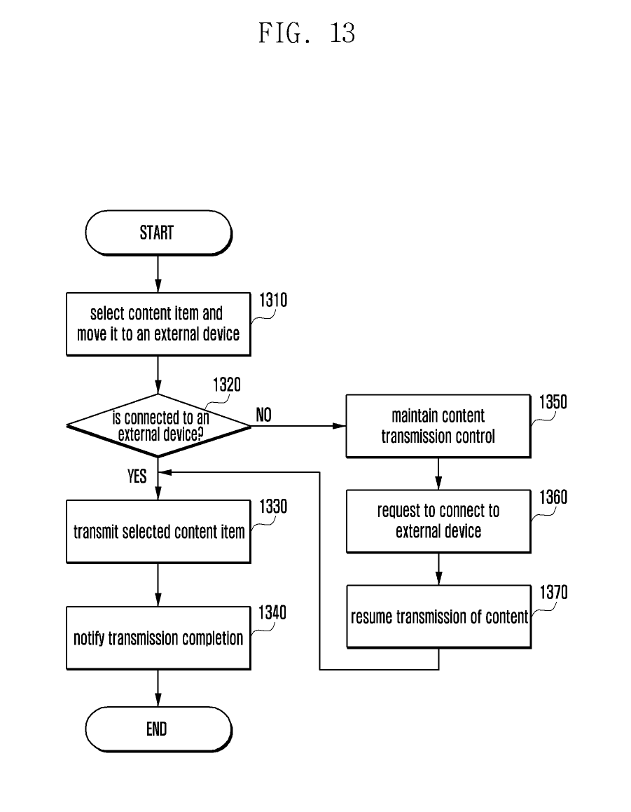

FIG. 13 is a flowchart that describes a method of sharing content of an electronic device according to various embodiments of the present disclosure.

Referring to FIG. 13, the electronic device may detect a user's input to share gathered content with external devices at operation 1310. The user's input to share gathered content with external devices may be, for example, a touch gesture that selects content and moves the selected content onto an external device identification object by dragging and dropping it.

The electronic device may determine whether it is connected to the selected external device at operation 1320. When the electronic device is connected to the selected external device in operation 1320, it may transmit the selected content to the external device at operation 1330.

On the contrary, when the electronic device is not connected to the selected external device in operation 1320, it may maintain a control command for instructing transmission of content at operation 1350. The electronic device may perform an authentication procedure for a request to connect to the selected external device at operation 1360.

When the electronic device is connected to the selected external device, it may resume transmission of content at operation 1370.

Meanwhile, although the electronic device is disconnected with the external device during the transmission of selected content, it may maintain the control command for transmission of content. When the electronic device is re-connected with the external device that it has been disconnected to, it may resume transmitting the content the transmission of which has been interrupted.

When the electronic device has transmitted the selected content to the external device, it may notify the user that the transmission has been completed at operation 1340.

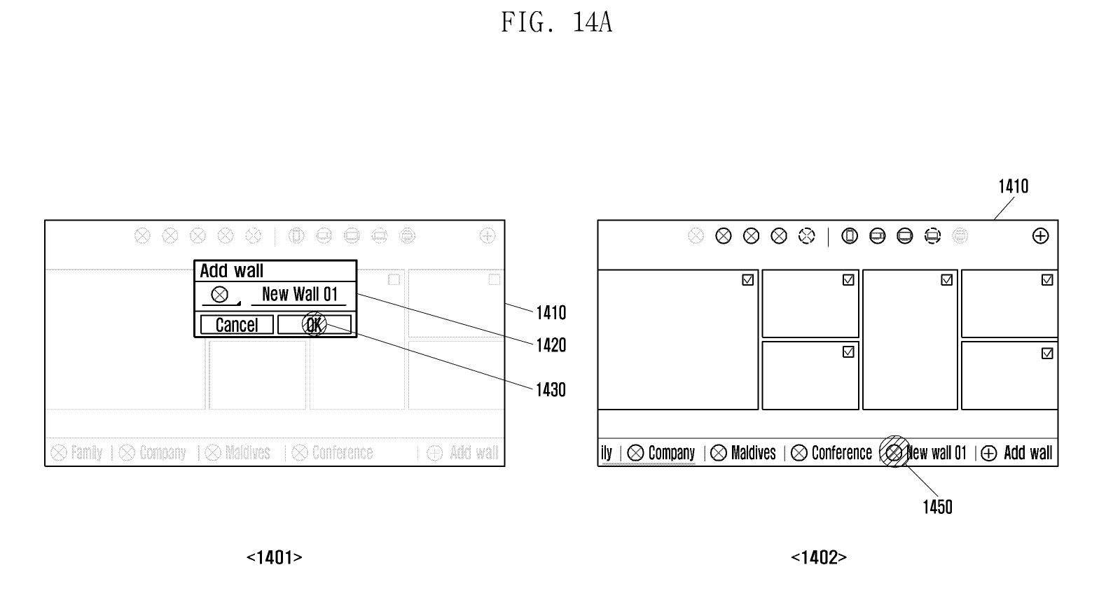

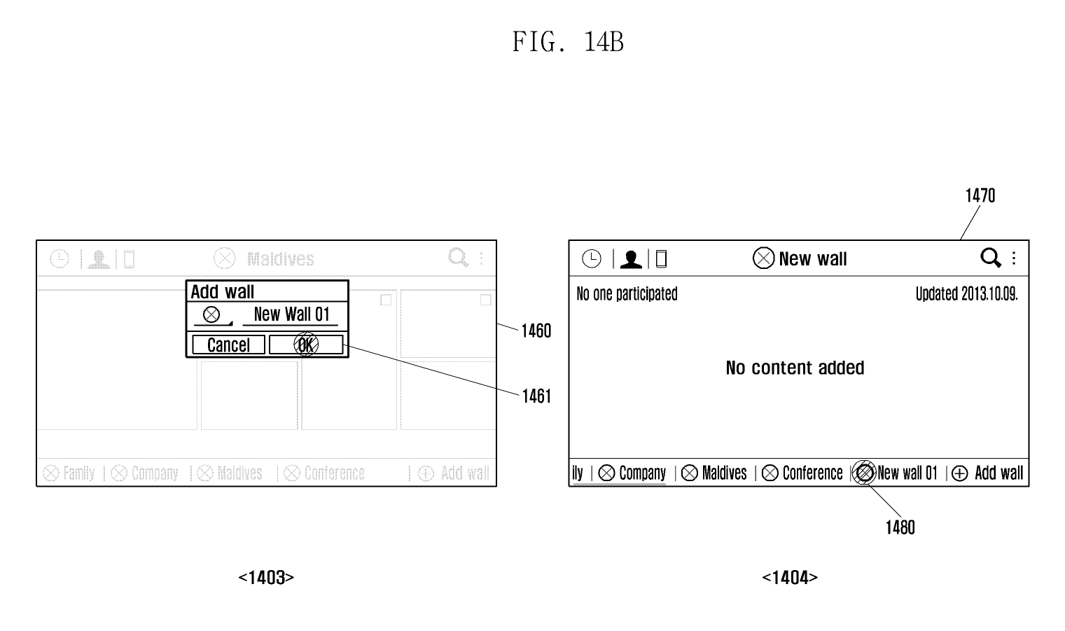

FIGS. 14A, 14B, 15, 16, 17, and 18 illustrate wall page screens on which gathered content items are managed according to various embodiments of the present disclosure.

Referring to FIGS. 14A and 14B, the electronic device may provide a wall page screen function for editing and managing gathered content items on a wall page screen.

The user may select an item ‘Add wall’ on a gate page screen 1410. When the electronic device detects a user's input for selecting an item ‘Add wall,’ it may display a setting window 1420 for adding a wall page screen on the display as shown in diagram 1401 of FIG. 14A. The setting window 1420 may be provided in a pop-up window form on the gate page screen, but is not limited thereto. The user may enter a title of a wall to the setting window 1420 and may accept a request to create a wall page screen by selecting the item 1430, i.e., OK button. In that case, the electronic device may add a created, wall page item 1450 to the wall item list as shown in diagram 1402 of FIG. 14A. The electronic device may allocate a storage space corresponding to the created wall page.

As shown in diagram 1403 of FIG. 14B, the user may select an item ‘Add wall’ in a state where the wall page screen 1460 is displayed. When the electronic device detects a user's input for selecting an item ‘Add Wall’ on the wall page screen 1460, it may display a setting window 1461 for adding a wall page screen on the display as shown in diagram 1403 of FIG. 14A. Since the setting window 1461 shown in diagram 1403 of FIG. 14B is the same as diagram 1401 of FIG. 14A, its detailed description will be omitted.

When the user enters a title of a wall to the setting window of the wall page screen and the wall page screen is thus created, the electronic device may switch the current screen to a newly created, wall page screen 1470 and may add a created, wall page item 1480 to the wall item list as shown in diagram 1404 of FIG. 14B.

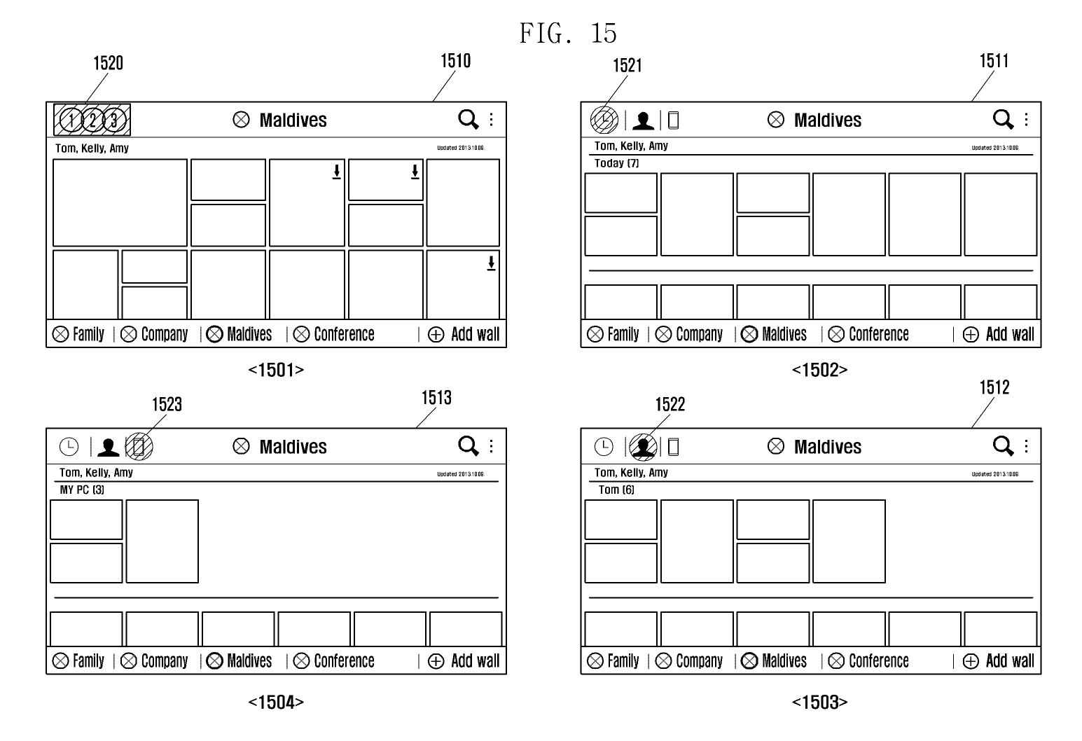

Referring to FIG. 15, the electronic device may support a function for sorting gathered content items on a wall page screen.

As shown in diagram 1501, the electronic device may display a wall page screen 1510 on the display. For example, when the user selects a wall page item of Maldives on the gate page screen, the electronic device may display a wall page screen 1510 of Maldives. The user may select an arrangement menu 1520 on the wall page screen 1510. The electronic device may sort and arrange gathered content items by the selected arrangement menu items.

As shown in diagram 1502, when the user selects a time series item 1521 from the arrangement menu items, the electronic device may sort and display gathered content items in time series. For example, the electronic device may sort and arrange gathered content items on the screen 1511 in time series, e.g., by update date, e.g., today's date, yesterday's date.

As shown in diagram 1503, when the user selects a content provider item 1522 from the arrangement menu items, the electronic device may sort and display content items by external devices that have obtained gathered content items. For example, a specific wall page screen may be designed to include content items that are gathered from external devices of accounts, Tom, Kelly, and Amy. The electronic device may sort and arrange the gathered content items by the content items gathered from the external devices of Tom's account, Kelly's account, and Amy's account, respectively, on the screen 1512 for sorting gathered content items by content provider items.

As shown in diagram 1504, when the user selects a personal device item 1523 from the arrangement menu items, the electronic device may sort and arrange content items obtained from personal devices by the personal devices. The electronic device may sort and arrange content items obtained from a first device and a second device by the first and second devices on the screen 1513 for arranging gathered content items by personal devices.

According to various embodiments of the present disclosure, the electronic device may support a function for searching for content via a wall page screen. For example, a user may makes a user's input for selecting a search menu on a wall page screen. The electronic device may call a keyword input window and search for content items based on a keyword of the keyword input window. The electronic device may call and display the searched content items.

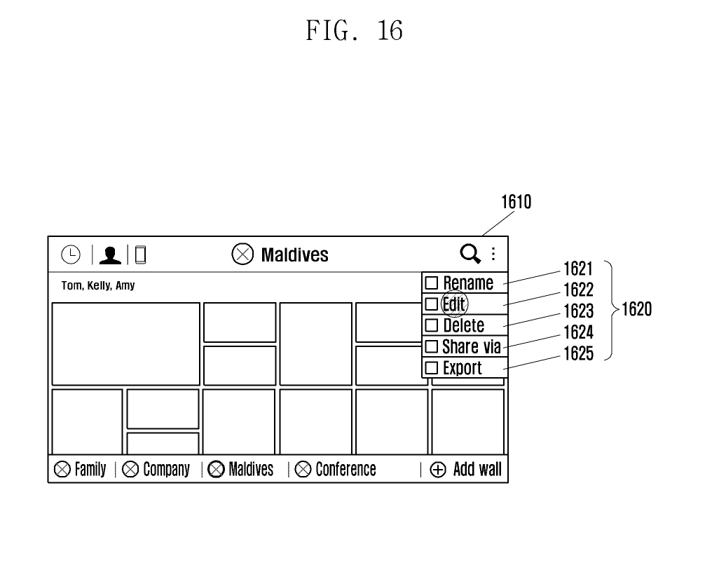

Referring to FIG. 16, the electronic device may provide an edit menu 1620 for editing screens in a wall page screen 1610. The edit menu 1620 may include items, e.g., Rename 1621, Edit 1622, Delete 1623, Share via 1624, and Export 1625. Rename 1621 may provide a function for calling a screen for editing the name of a wall page screen. Edit 1622 may provide a function for switching a current screen to a screen for selecting content items displayed on a wall page screen. Delete 1623 may provide a function for deleting a wall page item. Share via 1624 may provide a function for sharing a wall page screen with external devices. Extract 1625 may provide a function for exporting a content item to an image document object or a video object on a wall page screen. For example, when a user selects Share via 1624, the electronic device provides a list of applications for sharing content items on the screen. When an application is selected from the list, a wall page screen may be shared through the selected application. When a user selects Edit 1622, the electronic device switches the current screen to an edit screen for selecting content items.

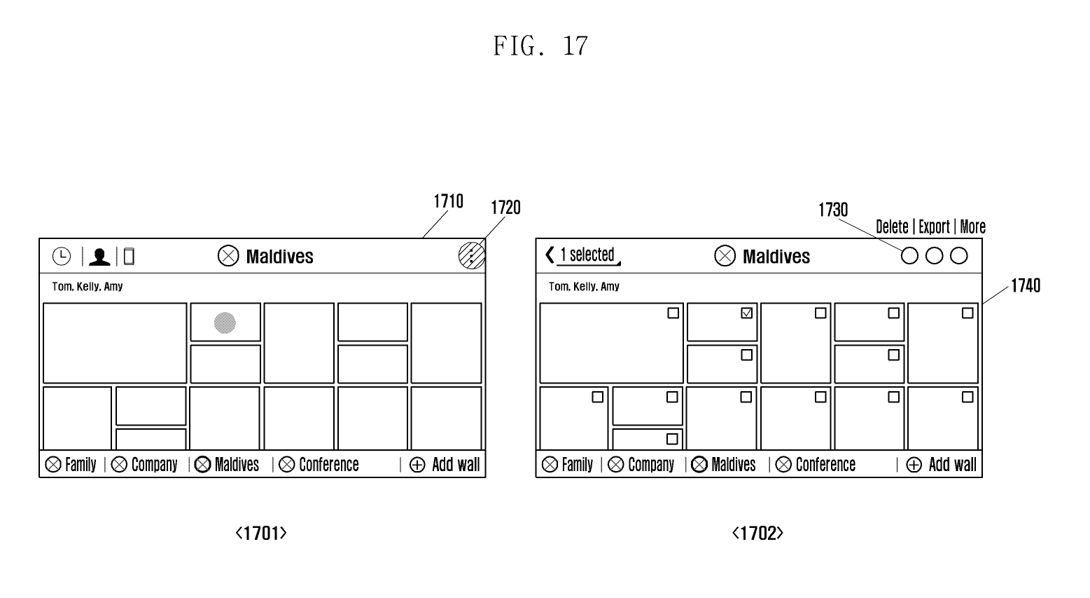

Referring to FIG. 17, the electronic device may provide a function for switching a wall page screen to an edit screen on which content items may be edited by touch inputs.

The user may make a touch-and-long-press input 1720 on a wall page screen 1710 as shown in diagram 1701. The electronic device may call Edit 1622 for editing content items shown in FIG. 16 and switch the screen to an edit screen 1740 for selecting content items, without requiring a selection, as shown in diagram 1702. The edit screen 1740 may display checkboxes for selecting gathered content items forming wall page screens and may provide an edit menu 1730 for deleting or exporting selected content items respectively.

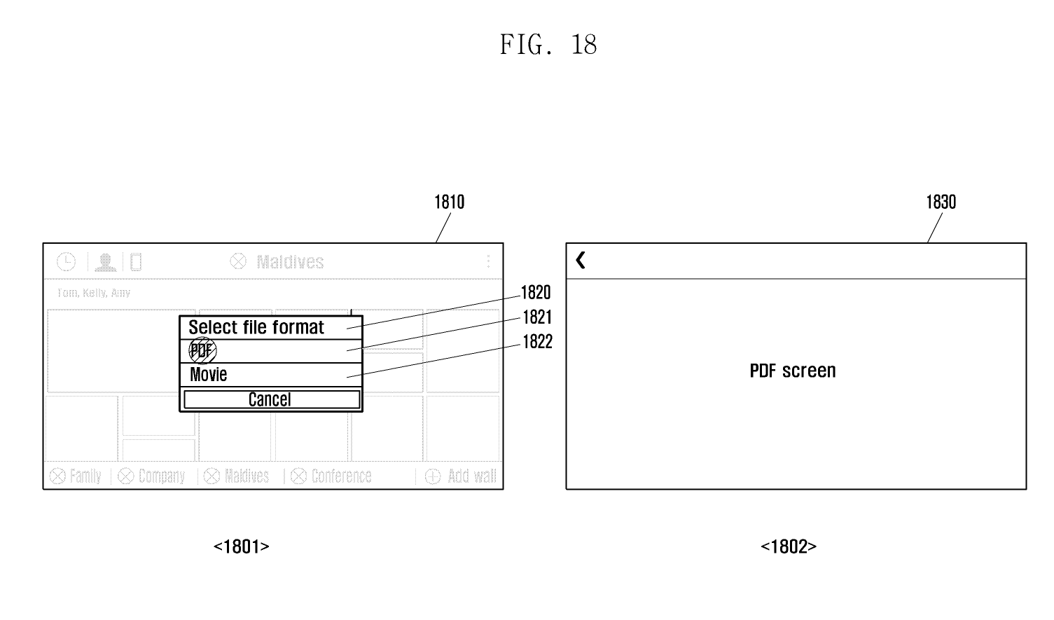

Referring to FIG. 18, the electronic device may provide a function for exporting gathered content items formed with wall pages to image document (e.g., PDF, etc.) or video content items, and sharing the exported wall page screen.

When Export 1625 of the edit menu 1620 for editing a wall page screen shown in FIG. 16 is selected, the electronic device may provide an export setting window 1820 on the wall page screen 1810 as shown in diagram 1801. The export setting window 1820 may include an item 1821 for exporting wall pages to image documents and an item 1822 for exporting extracting video content. When the user selects the item 1821, the electronic device may extract a corresponding wall page as an image document and display it on the screen 1830 as shown in diagram 1802.

For example, when a wall page is extracted in the format of an image document, the electronic device may create an image document so that it includes a specific number (N) of content items per page. When the gathered content of a wall page exceeds the specific number included in one page, the electronic device may create the image document as the next page. The electronic device may create an image document in such a way that target content is arranged at the beginning position of the first page and gathered content items are arranged in order of display. The size of content item to be displayed is 1×1 to 2×2, but is not limited thereto. The electronic device may create a wall page as an image document and store it in the format of an image document.

When a wall page is extracted in the format of video, the electronic device may create video content by sequentially editing content items included in a wall page. When creating video content, the electronic device may automatically insert a switching effect to each content item. The electronic device may flexibly adjust the size of a video screen according to the content size. For example, the electronic device may create content items each of which has a full screen size, in the format of video.

When a wall page is extracted as an image document or video content, the electronic device may transmit the extracted wall page to external devices. For example, the electronic device may transmit the extracted wall pages to storage location or folders of external devices which are set to share.

According to various embodiments of the present disclosure, at least part of the method (e.g., operations) or system (e.g., modules or functions) according to the various embodiments of the present disclosure can be implemented with instructions that can be conducted via various types of computers and stored in computer-readable storage media, as types of programming modules, for example. When one or more processors execute instructions, functions corresponding to the instructions can be performed. An example of the computer-readable storage media may be memory. At least part of the programming modules can be implemented (executed) by the processor, for example. At least part of the programming modules includes modules, programs, routines, sets of instructions or processes, etc., for example, in order to perform more than one function.

Examples of computer-readable media include: magnetic media, such as hard disks, floppy disks, and magnetic tape, optical media such as compact disc read only memory (CD-ROM) discs and digital versatile discs (DVDs), magneto-optical media, such as floptical disks, and hardware devices that are specially configured to store and perform program instructions (programming modules), such as ROM, random access memory (RAM), flash memory, etc. Examples of program instructions include machine code, such as produced by a compiler, and files containing higher level code that may be executed by the computer using an interpreter. The described hardware devices may be configured to act as one or more software modules in order to perform the operations and methods described above, or vice versa.

Modules or programming modules according to various embodiments of the present disclosure may include one or more components, remove part of them described above, or include new components. The operations performed by modules, programming modules, or the other components, according to the present disclosure, may be executed in serial, parallel, repetitive or heuristic fashion. Part of the operations can be executed in any other order, skipped, or executed with additional operations.

As described above, the electronic device according to various embodiments of the present disclosure may gather content items related to content displayed on the screen from the inside of the electronic device or from the external device, without receiving a specific keyword for search, and may provide the gathered content items to the user. The electronic device may provide content items in order of highest relevance to content displayed on the screen, and conveniently provide corresponding content items according to a user's search purpose. The electronic device may easily edit gathered content items through simple interactions, thereby easily managing and storing a set of corresponding content items.

According to various embodiments of the present disclosure, a storage medium stores instructions. The instructions are set to perform at least one operation when at least one processor executes the instructions. A method of providing content of an electronic device may include at least one operation, including detecting a gathering gesture, gathering content items from external devices and content items from the electronic device, in response to the detected gathering gesture, determining an order of displaying content items based on attributes of the gathered content items, and arranging and displaying the gathered content items according to the determined display order.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a communication unit configured to communicate with external devices;
a display configured to display at least one content item; and
a controller configured to:
detect a gathering gesture,
gather content items stored in the electronic device and content items from the external devices in response to the gathering gesture,
determine an order of displaying content items based on attributes of the gathered content items, and
arrange and display the gathered content items according to the determined display order.

2. The electronic device of claim 1, wherein the controller is further configured to determine whether target content is selected by the gathering gesture, and extract, when target content is selected, attributes of the target content item.

3. The electronic device of claim 2, wherein the controller is further configured to compare attributes of the gathered content items with those of the target content, and determine the order of displaying the gathered content items as an order of the largest number of attributes matching those of the target content.

4. The electronic device of claim 2, wherein the controller is further configured to determine, when target content is not selected, the order of displaying gathered content items based on an order of most recently created.

5. The electronic device of claim 2, wherein the controller is further configured to search for content items stored in the electronic device based on the attributes of the target content and gather the searched content items.

6. The electronic device of claim 2, wherein the controller is further configured to transmit the attributes of the target content to the external devices, search the external devices for content items based on the attributes of the target content, and obtain the searched content items from the external devices.

7. The electronic device of claim 1, wherein the controller is further configured to control the communication unit to connect to at least one of external devices that have been registered in connection in the electronic device, peripheral devices capable of making short-range communication, peripheral devices of other accounts' devices, the user's personal devices that have been registered in the electronic device, and servers connected to the electronic device via a network, and obtain gathered content from the connected external devices.

8. The electronic device of claim 1, wherein the communication unit is further configured to obtain content items that the external device has set to share or summary information about the content items.

9. The electronic device of claim 1, wherein the controller is further configured to detect a request to download original data of content items based on summary information about the content items, communicate with corresponding external device and download the original data of content item from the external device.

10. The electronic device of claim 1, wherein the controller is further configured to store the displayed, gathered content items in at least one page, and share the content items with the external device based on the stored page.

11. The electronic device of claim 10, wherein the controller is further configured to detect a content management request input in a state where the gathered content items are displayed and perform at least one of an update related to the gathered content, a change of the storage location, a deletion, a sharing, a page storage, a re-arrangement of content items, and an edit, according to the content management request input.

12. A method of providing content in an electronic device, the method comprising:
detecting a gathering gesture;
gathering content items stored in the electronic device and content items from external devices in response to the gathering gesture;
determining an order of displaying content items based on attributes of the gathered content items; and
arranging and displaying the gathered content items according to the determined display order.

13. The method of claim 12, wherein the gathering of the content items comprises:
searching, when the gathering gesture selects target content, for content items based on attributes of the target content, and gathered content the content items.

14. The method of claim 12, wherein the determining of the order of displaying content items comprises:
comparing, when the gathering gesture selects target content, attributes of the gathered content items with those of the target content; and
determining the order of displaying the gathered content items as an order of the largest number of attributes matching those of the target content.

15. The method of claim 12, wherein the determining of the order of displaying content items comprises:
determining, when target content is not selected, the order of displaying gathered content items based on an order of most recently created.

16. The method of claim 12, wherein the gathering of the content items comprises:
connecting communication to at least one of external devices that have been registered in connection in the electronic device, peripheral devices capable of making short-range communication, peripheral devices of other accounts' devices, the user's personal devices that have been registered in the electronic device, and servers connected to the electronic device via a network; and
obtaining gathered content items from the connected external device.

17. The method of claim 12, wherein the gathering of the content items comprises:
obtaining content items that the external device has set to share or obtaining summary information about content items from the external.

18. The method of claim 12, further comprising:
storing the displayed, gathered content items as one page screen.

19. The method of claim 12, wherein the gathering gesture comprises:
a grab gesture of a zero step type.

20. The method of claim 12, further comprising:
detecting a content management control input in a state where the gathered content items are displayed; and
displaying a content management screen related to the gathered content items in response to the content management control input.
